(19) United States
(12) Patent Application Publication
(10) Pub. No.: US 2013/0124877 A1
(43) Pub. Date: May 16, 2013

(54) COMMUNICATION METHOD, COMMUNICATION EQUIPMENT, AND STORAGE EQUIPMENT

(71) Applicant: Buffalo Inc., Nagoya-shi (JP)

(72) Inventor: Shinsuke SAITO, Nagoya-shi (JP)

(73) Assignee: Buffalo Inc., Nagoya-shi (JP)

(21) Appl. No.: 13/675,611

(22) Filed: Nov. 13, 2012

(30) Foreign Application Priority Data
Nov. 15, 2011 (JP) 2011-250027

(51) Int. Cl. G06F 12/00; G06F 12/14

(52) U.S. Cl. 713/193; 711/115; 711/E12.001; 711/E12.092

(57) ABSTRACT

A communication equipment, method and storage device cooperate to assist in connecting a storage device between different devices. The equipment includes an interface configured to be electrically connected to information terminal equipment. It also includes a communication mechanism that performs communication with storage equipment that has a region assigned to the communication equipment. It further includes a controller that transmits device class information indicating that the communication equipment is of a mass storage class to information terminal equipment in response to the communication equipment being connected to the information terminal equipment via the interface. The controller transfers an accepted inquiry command relating to a memory region to the storage equipment, and the controller receives memory region information relating to the assigned region from the storage equipment by the communication mechanism and transfers the received memory region information to the information terminal equipment.

### CROSS REFERENCE TO RELATED APPLICATION

The present application claims priority to Japanese Patent Application No. 2011-250027 filed on Nov. 15, 2011, the disclosure of which is hereby incorporated by reference in its entirety.

### BACKGROUND OF THE DISCLOSURE

1. Field of the Disclosure

The present disclosure relates to a communication method, communication equipment, and storage equipment.

2. Description of the Related Arts

In recent years, universal serial bus (USB) equipment used in connection to information terminal equipment (e.g. personal computer (PC)) has become popular as a memory device configured to store data. This USB equipment has a non-volatile memory (e.g. flash memory) configured to store data and the information terminal equipment recognizes this USB equipment as a device of the USB mass storage class.

Meanwhile, as a memory device to store data, storage equipment that performs communication with information terminal equipment via a network and performs data reading and writing has also become popular. The information terminal equipment establishes a secure communication path with such storage equipment and performs data writing/reading to/from the storage equipment via this communication path (refer to e.g. Japanese Patent Laid-open No. 2008-97591 and JP-T-2008-503799).

Such USB equipment has small size and light weight and therefore is convenient to carry around. However, the memory capacity thereof is lower than that of widely-used memory devices such as hard disk drives. Furthermore, it is easy to lose because having small size and light weight.

In contrast, the storage equipment that gives and receives data as a subject of reading and writing via the network is free from the problem of the memory capacity and also has measures to avoid security problems. However, in the case of such storage equipment, setting for enabling access from information terminal equipment to this storage equipment is complicated and the burden on a user of the information terminal equipment is large.

The present disclosure is made in view of the above-described current conditions and one of objects thereof is to provide a communication method, communication equipment, and storage equipment that are free from the need to carry out setting of information terminal equipment and allow a high-capacity memory region to be made with enhanced security.

### SUMMARY

Communication equipment according to one aspect of the present disclosure includes an interface configured to be electrically connected to information terminal equipment, a communication mechanism that performs communication with storage equipment having a specific memory region assigned to the communication equipment, and a controller that transmits device class information indicating that the communication equipment is of a mass storage class to the information terminal equipment after the interface is connected to the information terminal equipment. Furthermore, after the interface receives an inquiry command relating to a memory region of the communication equipment from the information terminal equipment, the controller transfers this received inquiry command to the storage equipment. Moreover, after the communication mechanism receives memory region information relating to the specific memory region from the storage equipment, the controller transfers this received memory region information to the information terminal equipment.

A corresponding communication method and storage equipment are also described.

### BRIEF DESCRIPTION OF THE DRAWINGS

FIG. 1 is an overall configuration diagram of a communication system according to an embodiment of the present disclosure;

FIG. 2 is a block diagram of a host PC according to the embodiment of the present disclosure;

FIG. 3 is a block diagram of a USB dongle according to the embodiment of the present disclosure;

FIG. 4 is a block diagram of a NAS according to the embodiment of the present disclosure;

FIG. 5 is an operation sequence diagram of initial setting operation in the communication system according to the embodiment of the present disclosure;

FIG. 6 is an operation sequence diagram of operation when the USB dongle is connected to the host PC after the completion of the initial setting;

FIG. 7 is an operation sequence diagram of operation when data reading is performed;

FIG. 8 is an operation sequence diagram of operation when data writing is performed;

FIG. 9 is an overall configuration diagram of the communication system according to a first modification example of the embodiment of the present disclosure;

FIG. 10 is a block diagram of the NAS according to the first modification example of the embodiment of the present disclosure;

FIG. 11 is an overall configuration diagram of the communication system according to a second modification example of the embodiment of the present disclosure;

FIG. 12 is a block diagram of the USB dongle according to the second modification example of the embodiment of the present disclosure;

FIG. 13 is a block diagram of the USB dongle according to a third modification example of the embodiment of the present disclosure;

FIG. 14 is a block diagram of the NAS according to the third modification example of the embodiment of the present disclosure;

FIG. 15 is a block diagram of the USB dongle according to a fourth modification example of the embodiment of the present disclosure; and

FIG. 16 is a block diagram of the NAS according to the fourth modification example of the embodiment of the present disclosure.

### DETAILED DESCRIPTION OF EMBODIMENTS

One aspect of an embodiment of the present disclosure will be described with reference to the drawings. The same part is given the same symbol in the following drawings.

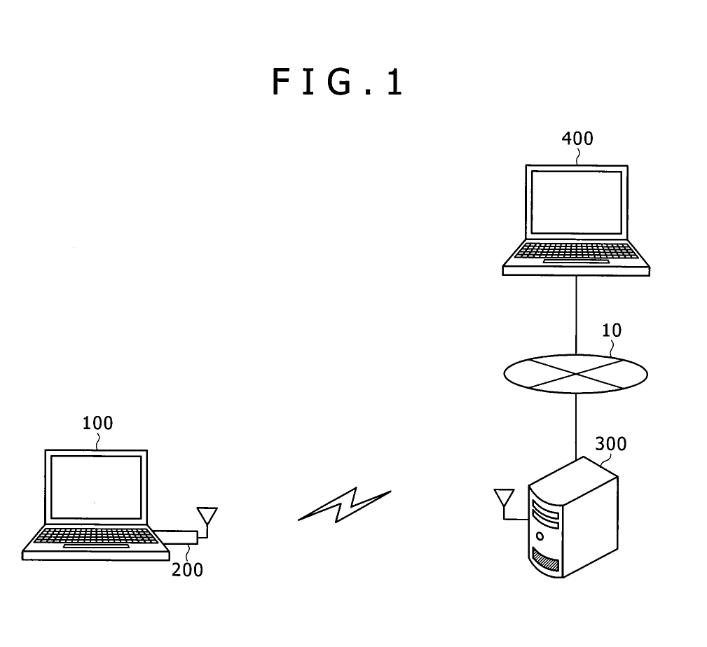

FIG. 1 is an overall configuration diagram of a communication system according to the present aspect of the embodiment. As shown in FIG. 1, the communication system according to the present aspect of the embodiment includes a host PC 100, a USB dongle 200, a network attached storage (NAS) 300, and an administrator PC 400. The NAS 300 and the administrator PC 400 are connected to a network 10 such as a local area network (LAN).

The host PC 100 corresponds to information terminal equipment. The USB dongle 200 corresponds to communication equipment. The NAS 300 corresponds to storage equipment. Although the following description will be made by taking dongle-type USB equipment (USB dongle 200) as one example of the communication equipment, the communication equipment may be of a type other than the dongle type. The information terminal equipment as host equipment of the USB dongle 200 is not limited to a PC and may be another piece of equipment.

The host PC 100 is a notebook PC or a desktop PC operated by the user and operates as host equipment of the USB dongle 200. The host PC 100 is compatible with USB Plug and Play.

The USB dongle 200 is connected to the host PC 100. This USB dongle 200 performs short-distance wireless communication with the NAS 300. In one aspect of the present embodiment, the short-distance wireless communication is communication compliant with the wireless LAN (e.g. IEEE 802.11 standard).

The NAS 300 is so configured as to include a memory device such as a hard disk drive. This NAS 300 performs short-distance wireless communication with the USB dongle 200. The USB dongle 200 and the NAS 300 perform communication compliant with the wireless LAN when existing in such a range as to be capable of communicating with each other (in a wireless LAN area).

In one aspect of the present embodiment, the host PC 100 issues an order to read or write data to the USB dongle 200. Then, the USB dongle 200 transmits the order to read or write data from the host PC 100 to the NAS 300 while performing communication with the NAS 300. The USB dongle 200 gives or receives data as a subject of reading or writing to or from the host PC 100 and the USB dongle 200 gives or receives this data to or from the NAS 300.

That is, the USB dongle 200 functions as a virtual memory device for the host PC 100. In this example, the actual memory device is the NAS 300. That is, the NAS 300 provides a substantial memory region for the host PC 100.

When use of the USB dongle 200 is started, this USB dongle 200 is connected to the NAS 300 for initial setting. The NAS 300 carries out initial setting of the USB dongle 200 when use of the USB dongle 200 is started. Details of the operation of this initial setting will be described later.

The administrator PC 400 is a notebook PC or a desktop PC operated by an administrator. The administrator operates this administrator PC 400 to carry out initial setting for the NAS 300 via the network 10.

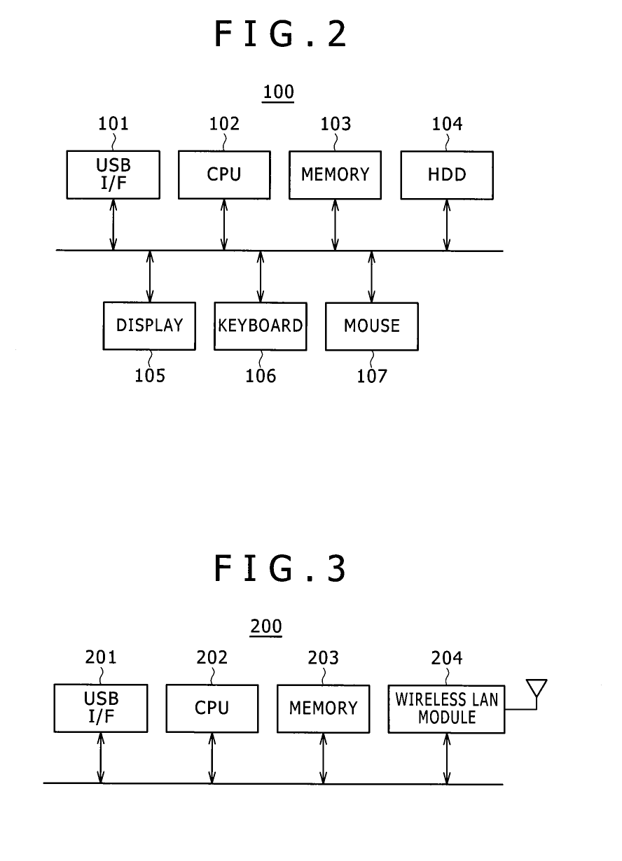

FIG. 2 is a configuration block diagram showing one example of the host PC 100. As shown in FIG. 2, the host PC 100 is so configured as to include a USB I/F 101, a CPU 102, a memory 103, a hard disk drive (HDD) 104, a display 105, a keyboard 106, and a mouse 107.

The USB I/F 101 is an interface (I/F) configured in conformity with the USB standard and the USB dongle 200 is connected thereto in one aspect of the present embodiment. The USB I/F 101 transmits and receives various kinds of command and data to and from the USB I/F of the connected equipment under control by the CPU 102.

The CPU 102 runs a control program stored in the memory 103 or the HDD 104. The specific operation of this CPU 102 will be described later. In one aspect of the present embodiment, this CPU 102 executes processing as an operating system (OS) including a USB driver.

The memory 103 stores the control program run by the CPU 102. Furthermore, this memory 103 operates also as a work area of the CPU 102. This control program may be one stored in the HDD 104. The HDD 104 is a computer-readable recording medium and stores various kinds of data. In this HDD 104, a control program that is stored in a computer-readable recording medium such as a DVD-ROM or is provided via a network or the like may be installed.

The display 105 displays information in accordance with an order input from the CPU 102. The keyboard 106 and the mouse 107 accept user's operation and output a signal indicating the content of this operation to the CPU 102.

The administrator PC 400 has a block configuration similar to that of the host PC 100 and therefore detailed description thereof is omitted.

FIG. 3 is a configuration block diagram relating to one example of the USB dongle 200. As shown in FIG. 3, the USB dongle 200 includes a USB I/F 201, a CPU 202, a memory 203, and a wireless LAN module 204.

The USB I/F 201 is an I/F configured in conformity with the USB standard and is connected to the host PC 100 or the NAS 300 in a certain aspect of the present embodiment. The USB I/F 201 transmits and receives various kinds of command and data to and from the USB I/F of the host PC 100 or the NAS 300 as the connected equipment in accordance with an order input from the CPU 202. This USB I/F 201 may receive power supply from the USB I/F of the connected equipment.

The CPU 202 runs a control program stored in the memory 203. The operation of this CPU 202 will be described later. The memory 203 stores the control program run by the CPU 202. Furthermore, this memory 203 operates also as a work area of the CPU 202. In one aspect of the present embodiment, this memory 203 includes a flash memory configured to store the control program, setting information, and so forth and a RAM used as a data buffer. These CPU 202 and memory 203 correspond to a control means in the USB dongle 200.

In this memory 203, the identification information and device class information of the USB dongle 200 are stored in advance. The identification information of the USB dongle 200 is e.g. a vendor ID, a product ID, a MAC address, a UDID, and a UUID of the USB dongle 200. The device class information is information included in Device Descriptor defined in the USB standard and indicates the kind of USB equipment. In one aspect of the present embodiment, the device class information stored in this memory 203 indicates a USB mass storage device.

The wireless LAN module 204 is a communication module configured to perform wireless LAN communication in accordance with an order input from the CPU 202. In one aspect of the present embodiment, this wireless LAN module 204 has a function as a wireless LAN child device. Furthermore, in one aspect of the present embodiment, this wireless LAN module 204 corresponds to the communication means in the USB dongle 200.

As above, in one aspect of the present embodiment, the control program, the setting information, and so forth are stored in this memory 203. However, the CPU 202 carries out control in such a manner that data (user data) ordered to be written from the host PC 100 or another device is not stored in this memory 203. That is, even when this USB dongle 200 includes a non-volatile memory, control is so carried out that user data is not stored in this non-volatile memory. In other words, this USB dongle 200 does not include a non-volatile memory to store user data.

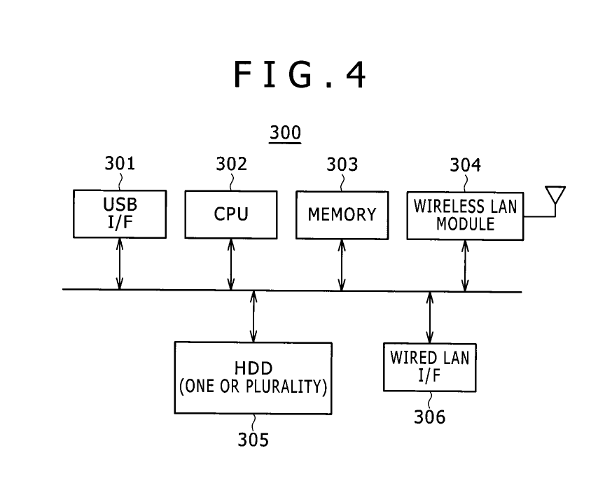

FIG. 4 is a configuration block diagram relating to one example of the NAS 300. As shown in FIG. 4, the NAS 300 includes a USB I/F 301, a CPU 302, a memory 303, a wireless LAN module 304, one or plural HDDs 305, and a wired LAN I/F 306.

The USB I/F 301 is an I/F configured in conformity with the USB standard and the USB dongle 200 is connected thereto in one aspect of the present embodiment. The USB I/F 301 transmits and receives various kinds of command and data to and from the USB I/F of the USB dongle 200 or another device as the connected equipment in accordance with an order input from the CPU 302.

The CPU 302 runs a control program stored in the memory 303 or the HDD 305. The operation of this CPU 302 will be described later. The memory 303 stores the control program run by the CPU 302. Furthermore, this memory 303 operates also as a work area of the CPU 302. In one aspect of the present embodiment, these CPU 302 and memory 303 correspond to the control means in the NAS 300.

The wireless LAN module 304 is a communication module for performing wireless LAN communication in accordance with an order input from the CPU 302. In one aspect of the present embodiment, the wireless LAN module 304 operates as a wireless LAN access point. Furthermore, in one aspect of the present embodiment, this wireless LAN module 304 corresponds to the communication means in the NAS 300.

The HDD 305 stores data and reads out stored data in accordance with an order input from the CPU 302. This HDD 305 may be treated as a RAID disk array. In one aspect of the present embodiment, this HDD 305 corresponds to the memory means in the NAS 300. The memory means in the NAS 300 is not limited to the HDD and may be e.g. a solid state drive (SSD).

In one aspect of the present embodiment, in the memory 303 or the HDD 305, information for establishing a wireless LAN session (ESSID and encryption key) and login information of the iSCSI are stored in advance as setting information for performing communication with the NAS 300. Furthermore, an encryption key for encryption/decryption of data may be stored in advance in the memory 303 or the HDD 305. The iSCSI is a standard for using the SCSI protocol on the TCP/IP and the provisions thereof exist in RFC3720 and so forth.

The wired LAN I/F 306 is connected to the network 10 in a wired manner and performs communication with the administrator PC 400 via the network 10 in accordance with an order input from the CPU 302.

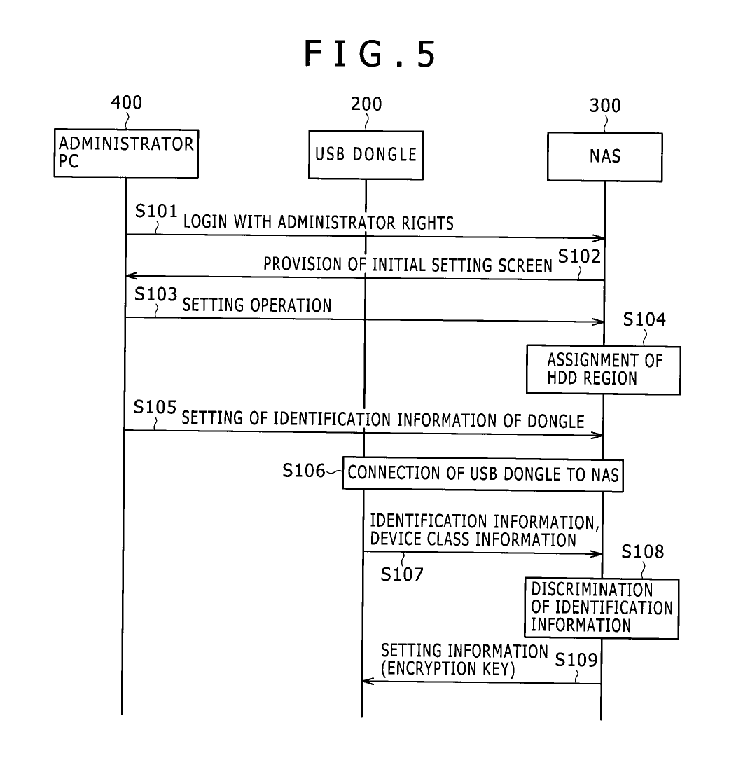

Next, the operation of the communication system according to one aspect of the present embodiment will be described. FIG. 5 is an operation sequence diagram of initial setting operation in the communication system according to one aspect of the present embodiment.

As shown in FIG. 5, in a step S101, the administrator operates the administrator PC 400 to make login to the NAS 300 with the administrator rights.

In a step S102, the CPU 302 of the NAS 300 outputs information for making the administrator PC 400 display an initial setting screen to the wired LAN I/F 306 to transmit the information to the administrator PC 400 via the network 10.

In a step S103, the administrator PC 400 displays the initial setting screen based on the information received from the NAS 300. By operation on this initial setting screen, the administrator specifies the range of the memory region of the NAS 300 (memory region of the HDD 305) that should be assigned to the USB dongle 200 by a logical address. The administrator PC 400 transmits information on the specified logical address to the NAS 300.

If there are plural USB dongles 200, the administrator specifies logical address ranges different from each other for each USB dongle 200.

In a step S104, upon reception of the information on the logical address by the wired LAN I/F 306, the CPU 302 of the NAS 300 sets the specified range of the memory region of the HDD 305 as an assigned region in accordance with the received information.

In a step S105, the administrator inputs the identification information of the USB dongle 200 by operation on the initial setting screen. The administrator PC 400 transmits the input identification information to the NAS 300. As described above, the identification information of the USB dongle 200 is e.g. vendor ID, product ID, MAC address, UDID, and UUID of the USB dongle 200.

Upon reception of the identification information of the USB dongle 200 by the wired LAN I/F 306, the CPU 302 of the NAS 300 stores this received identification information in the memory 303 or the HDD 305. This stored identification information is used for discrimination as to whether or not the USB dongle 200 as the communication counterpart is permitted to access the NAS 300.

Furthermore, the CPU 302 associates the logical address information of the assigned region set in the step S104 with the received identification information of the USB dongle 200 and stores the associated pieces of information in the memory 303 or the HDD 305. Thereby, the USB dongle 200 and the assigned region are associated with each other.

In a step S106, the USB dongle 200 is connected to the NAS 300 by the administrator for example. That is, the USB I/F 201 of the USB dongle 200 is inserted into the USB I/F 301 of the NAS 300.

In a step S107, the CPU 202 of the USB dongle 200 detects the connection to another piece of equipment and transmits the identification information and device class information of the USB dongle 200 from the USB I/F 201.

In a step S108, the CPU 302 of the NAS 300 compares the identification information received by the USB I/F 301 from the USB dongle 200 with the identification information stored in the memory 303 or the HDD 305 to discriminate whether or not these pieces of identification information correspond with each other. If it is discriminated that they correspond with each other, the CPU 302 determines that the USB dongle 200 is permitted to access the NAS 300 and continues the initial setting. In contrast, if the identification information received from the USB dongle 200 does not correspond with the identification information stored in the memory 303 or the HDD 305 in the step S108, the CPU 302 determines that the USB dongle 200 is not permitted to access the NAS 300 and stops the initial setting.

If the initial setting is continued, in a step S109, the CPU 302 of the NAS 300 transmits information for establishing a wireless LAN session (ESSID and encryption key), login information of the iSCSI, and an encryption key from the USB I/F 301.

When the information for establishing a wireless LAN session (ESSID and encryption key), the login information of the iSCSI, and the encryption key are received by the USB I/F 201, the CPU 202 of the USB dongle 200 stores these pieces of information in the memory 203. Thereby, the initial setting of the USB dongle 200 is completed.

That is, various kinds of information for establishing a wireless LAN session with the NAS 300 are set in the USB dongle 200 before connection to the host PC 100. This setting method is not limited to a method of connecting the NAS 300 as the communication subject and the USB dongle 200 as described above.

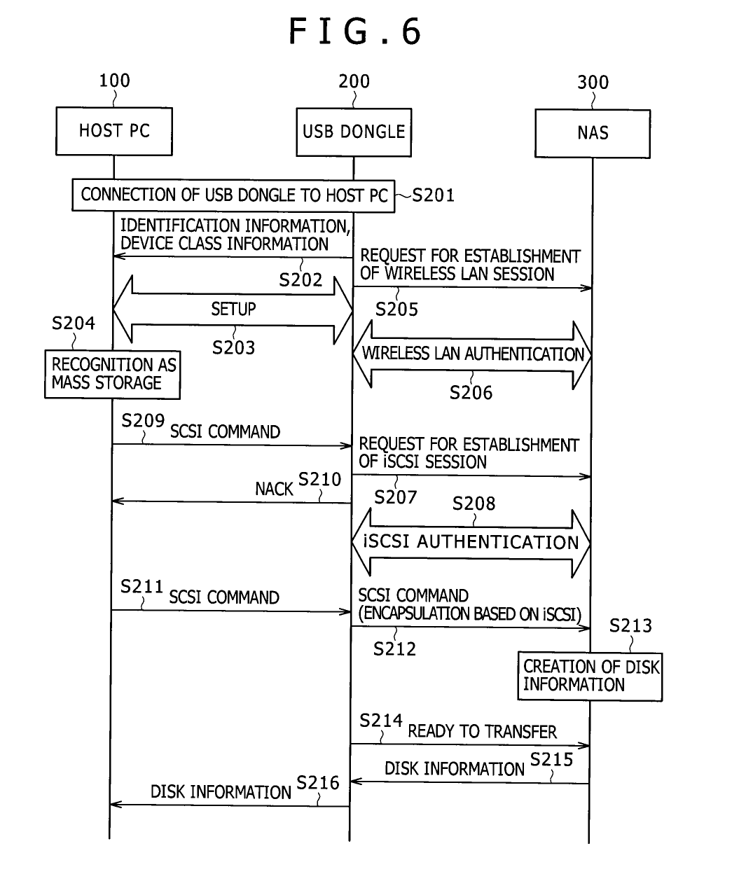

FIG. 6 is an operation sequence diagram of operation when the USB dongle 200 is connected to the host PC 100 after the completion of the initial setting.

As shown in FIG. 6, in a step S201, the user connects the USB dongle 200 to the host PC 100. That is, the USB I/F 201 of the USB dongle 200 is inserted into the USB I/F 101 of the host PC 100.

In a step S202, the CPU 202 of the USB dongle 200 detects the connection to another piece of equipment and transmits the identification information and device class information of the USB dongle 200 from the USB I/F 201.

In a step S203, the CPU 102 of the host PC 100 carries out setup by the function as the USB driver of the OS.

In a step S204, the CPU 102 of the host PC 100 recognizes the USB dongle 200 as a device of the USB mass storage class based on the device class information received by the USB I/F 101.

In a step S205, in parallel to the setup with the host PC 100, the CPU 202 of the USB dongle 200 detects a beacon signal received by the wireless LAN module 204 from the wireless LAN module 304 of the NAS 300 and transmits a request for establishment of a wireless LAN session to the NAS 300 from the wireless LAN module 204.

In a step S206, the CPU 202 of the USB dongle 200 carries out operation of authentication compliant with the wireless LAN with the wireless LAN module 304 of the NAS 300 by using the information for establishing a wireless LAN session (ESSID and encryption key), stored in the memory 203 by the initial setting. The CPU 302 of the NAS 300 checks the information for establishing a wireless LAN session (ESSID and encryption key), received by the wireless LAN module 304, against the information stored in the memory 303 or the HDD 305, and determines that the authentication succeeded if these pieces of information correspond with each other. If the CPU 302 of the NAS 300 determines that it succeeded in the authentication compliant with the wireless LAN, a wireless LAN session is established between the USB dongle 200 and the NAS 300. The CPU 302 of the NAS 300 may specify the assigned region for the USB dongle 200 with which the wireless LAN session is established based on the identification information of the USB dongle 200 obtained in the process of the authentication processing compliant with the wireless LAN.

In a step S207, in response to the establishment of the wireless LAN session, the CPU 202 of the USB dongle 200 transmits a request for establishment of an iSCSI session to the NAS 300 from the wireless LAN module 204.

In a step S208, the CPU 202 of the USB dongle 200 carries out iSCSI authentication with the NAS 300 by using the login information of the iSCSI, stored in the memory 203. The CPU 302 of the NAS 300 checks the login information of the iSCSI, received by the wireless LAN module 304, against the information stored in the memory 303 or the HDD 305, and determines that the authentication succeeded if they correspond with each other. If the CPU 302 determines that it succeeded in the iSCSI authentication, an iSCSI session is established between the USB dongle 200 and the NAS 300. In this case, the USB dongle 200 serves as the iSCSI initiator and the NAS 300 serves as the iSCSI target.

Meanwhile, in a step S209, the CPU 102 of the host PC 100, which recognizes the USB dongle 200 as a USB mass storage device, transmits a SCSI command for inquiring disk information (memory capacity, whether or not the disk can be used, etc.) (hereinafter, referred to as the “inquiry command”) from the USB I/F 101 to the USB dongle 200.

In a step S210, the CPU 202 of the USB dongle 200 transmits a negative acknowledgement (NACK) responding to the inquiry command from the USB I/F 201 because the iSCSI session has not yet been established at the timing of the reception of the inquiry command by the USB I/F 201.

The CPU 102 receives the negative acknowledgement and then, in a step S211, retransmits the inquiry command from the USB I/F 101.

In a step S212, because the iSCSI session has already been established at the timing of the reception of the inquiry command by the USB I/F 201, the CPU 202 of the USB dongle 200 encapsulates the inquiry command in accordance with the iSCSI protocol and transmits the encapsulated inquiry command from the wireless LAN module 204. The identification information of the USB dongle 200 is included in this encapsulated inquiry command.

In a step S213, the wireless LAN module 304 receives the encapsulated inquiry command. Thereupon, based on the identification information included in this encapsulated inquiry command and the information stored in the memory 303 or the HDD 305, the CPU 302 of the NAS 300 discriminates the assigned region associated with the USB dongle 200 specified by this identification information. Furthermore, the CPU 302 creates disk information (memory region information) relating to this discriminated assigned region.

In a step S214, the CPU 202 of the USB dongle 200 transmits “Ready to Transfer” indicating the completion of ensuring of a buffer region from the wireless LAN module 204.

In a step S215, upon reception of “Ready to Transfer” by the wireless LAN module 304, the CPU 302 of the NAS 300 transmits the disk information (memory region information) relating to the assigned region for the USB dongle 200 as the transmission source of this “Ready to Transfer” from the wireless LAN module 304.

In a step S216, upon reception of the disk information by the wireless LAN module 204, the CPU 202 of the USB dongle 200 transmits this disk information from the USB I/F 201. In the host PC 100, the USB I/F 101 receives the disk information and thereupon the CPU 102 displays this disk information on the display 105. That is, this disk information is presented to the user as if it were information on a disk existing in the USB dongle 200 (although actually the region equivalent to the disk to store data of the user (hereinafter, referred to as user data if the data needs to be distinguished from the setting information and so forth particularly) does not exist in the USB dongle 200).

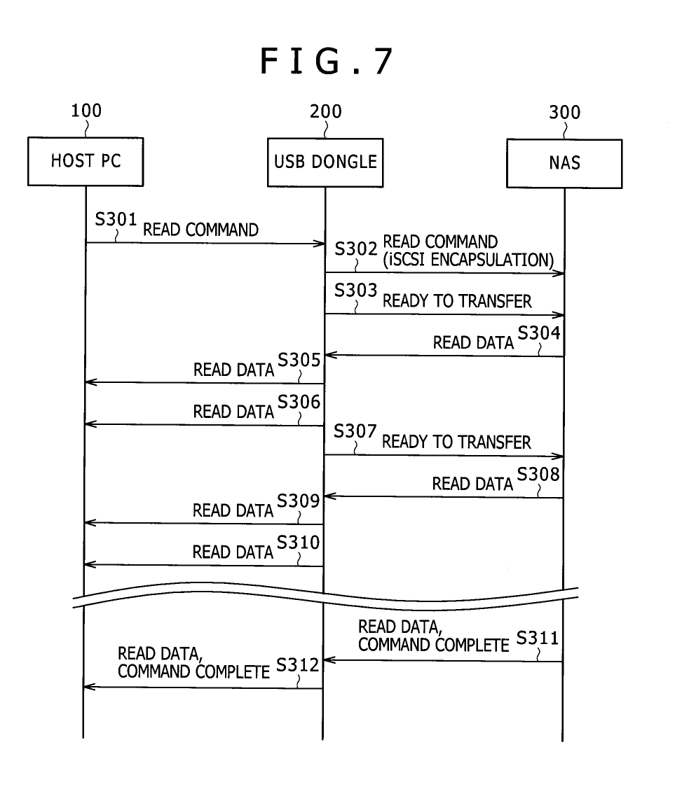

FIG. 7 is an operation sequence diagram of operation when data reading is performed after the completion of the operation of FIG. 6.

As shown in FIG. 7, when the need to read out data stored in the NAS 300 is generated due to e.g. response to user's operation input from the keyboard 106 and the mouse 107, the CPU 102 of the host PC 100 transmits a read command in the SCSI from the USB I/F 101 in a step S301. In a step S302, the CPU 202 of the USB dongle 200 encapsulates the read command received by the USB I/F 201 in accordance with the iSCSI protocol and transmits the encapsulated read command from the wireless LAN module 204.

In a step S303, the CPU 202 of the USB dongle 200 ensures a buffer region for read data and transmits “Ready to Transfer” from the wireless LAN module 204.

In a step S304, the wireless LAN module 304 receives the read command and “Ready to Transfer.” Thereupon, the CPU 302 of the NAS 300 reads out the data as the subject of the reading request from the assigned region that exists in the HDD 305 and is associated with the USB dongle 200 as the transmission source of the read command. The CPU 302 transmits the read data from the wireless LAN module 304. Depending on the size of the buffer region ensured in the USB dongle 200, the data as the subject of the reading may be so transmitted as to be divided into plural portions instead of collectively transmitting the whole of the data at one time. Furthermore, at this time, the CPU 302 transmits the data after performing encryption by using the encryption key shared with the USB dongle 200.

In steps S305 and S306, the CPU 202 of the USB dongle 200 stores the read data received by the wireless LAN module 204 in the buffer region and sequentially transmits the read data to the host PC 100. At this time, the CPU 202 transmits the data to the host PC 100 after performing decryption by using the encryption key shared with the NAS 300.

In a step S307, the CPU 202 of the USB dongle 200 transmits “Ready to Transfer” from the wireless LAN module 204 when the buffer region becomes empty. Then, the NAS 300 and the USB dongle 200 repeatedly carry out steps S308 to S310 to transfer the data as the subject of the reading to the host PC 100.

In a step S311, the CPU 302 of the NAS 300 transmits the last portion of the read data from the wireless LAN module 304. In addition, it transmits status information representing whether the data reading has been normally ended or resulted in error stop from the wireless LAN module 304. Here, suppose that the data reading has been normally ended (command complete).

In a step S312, upon reception of the read data and the status information by the wireless LAN module 204, the CPU 202 of the USB dongle 200 transmits the received read data and status information from the USB I/F 201. Thereby, the CPU 102 of the host PC 100 determines that the data reading has been completed based on the status information received by the USB I/F 101.

Furthermore, in the above-described read operation, the CPU 302 of the NAS 300 may create a log with association of the identification information of the USB dongle 200 with the time when the reading is performed and store the created log in the memory 303 or the HDD 305.

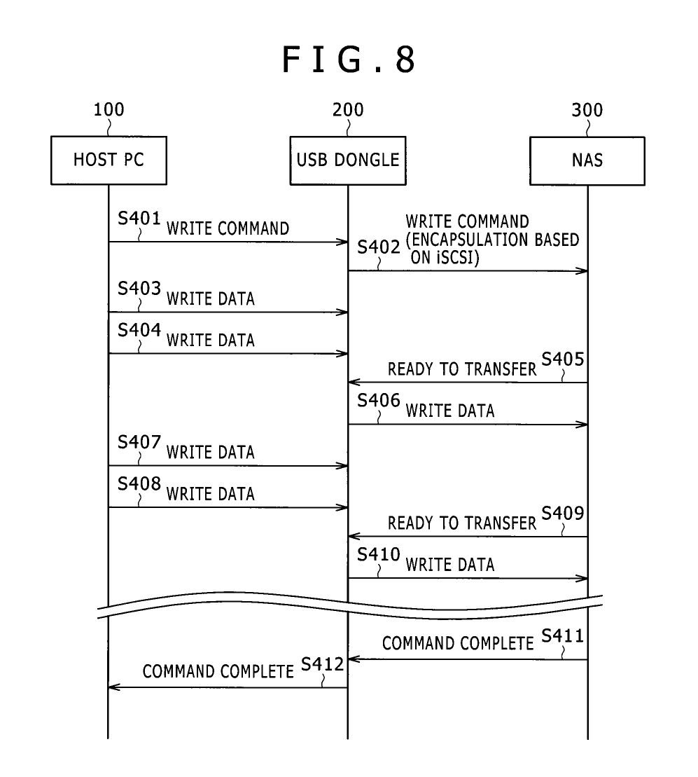

FIG. 8 is an operation sequence diagram of operation when data writing is performed after the completion of the operation of FIG. 6.

As shown in FIG. 8, when the need to write data to the NAS 300 is generated due to e.g. response to user's operation input from the keyboard 106 and the mouse 107, the CPU 102 of the host PC 100 transmits a write command in the SCSI from the USB I/F 101 in a step S401.

In a step S402, the CPU 202 of the USB dongle 200 encapsulates the write command received by the USB I/F 201 in accordance with the iSCSI protocol and transmits the encapsulated write command from the wireless LAN module 204.

In steps S403 and S404, the CPU 102 of the host PC 100 sequentially transmits the data that is stored in the memory 103 or the HDD 104 and is the subject of the writing from the USB I/F 101. The CPU 202 of the USB dongle 200 stores the write data received by the USB I/F 201 in a buffer region.

In a step S405, the CPU 302 of the NAS 300 ensures a buffer region for the write data and transmits “Ready to Transfer” from the wireless LAN module 304.

In a step S406, upon reception of “Ready to Transfer” by the wireless LAN module 204, the CPU 202 of the USB dongle 200 transmits the write data stored in the buffer region from the wireless LAN module 204. At this time, the CPU 202 transmits the data after performing encryption by using the encryption key shared with the NAS 300.

When the write data is received by the wireless LAN module 304 of the NAS 300, the CPU 302 of the NAS 300 writes the data as the subject of the writing into the assigned region that exists in the HDD 305 and is associated with the USB dongle 200 as the transmission source of the writing subject data. At this time, the CPU 302 performs the writing after decrypting the data by using the encryption key shared with the USB dongle 200.

If the data as the subject of the writing cannot be collectively transmitted at one time, the steps S407 to S410 are repeated to carry out the write operation.

In a step S411, upon the completion of the data writing, the CPU 302 of the NAS 300 transmits status information representing whether the data writing has been normally ended or resulted in error stop from the wireless LAN module 304. Here, suppose that the data writing has been normally ended (command complete).

In a step S412, upon reception of the status information by the wireless LAN module 204, the CPU 202 of the USB dongle 200 transmits the received status information from the USB I/F 201. Then, the CPU 102 of the host PC 100 determines that the data writing has been completed based on the status information received by the USB I/F 101.

Furthermore, in the above-described write operation, the CPU 302 of the NAS 300 may create a log with association of the identification information of the USB dongle 200 with the time when the writing is performed and store the created log in the memory 303 or the HDD 305.

As described above, in one aspect of the present embodiment, the USB dongle 200, which does not have non-volatile memory for storing data, is connected to the host PC 100 and thereafter transmits the device class information indicating that this USB dongle 200 is of the USB mass storage class to the host PC 100. Due to this, the host PC 100 treats the USB dongle 200 as a general device of the USB mass storage class.

Therefore, there is no need to carry out the setting necessary for access to the NAS 300 on the side of the host PC 100. Furthermore, the USB dongle 200 according to one aspect of the present embodiment does not have non-volatile memory for storing user data. Thus, information leakage does not occur even when the USB dongle 200 is lost. This can enhance the security.

Moreover, the USB dongle 200 establishes communication with the NAS 300 having the assigned region associated with the USB dongle 200 as its own self. The host PC 100 recognizes the USB dongle 200 as a device of the USB mass storage class in accordance with the device class information and then transmits an inquiry command relating to the memory region of the USB dongle 200 to the USB dongle 200. After receiving the inquiry command from the host PC 100, the USB dongle 200 transfers this received inquiry command to the NAS 300. After receiving the inquiry command from the USB dongle 200, the NAS 300 transmits disk information relating to the specific memory region to the USB dongle 200. After receiving the disk information from the NAS 300, the USB dongle 200 transfers this received disk information to the host PC 100. This allows the memory region of the NAS 300 (assigned region associated with the USB dongle 200) to be shown to the host PC 100 as if this memory region were a memory region existing in the USB dongle 200. In other words, the memory region of the USB dongle 200 seen from the host PC 100 can be rendered a memory region having comparatively-high capacity generally because being the memory region of the NAS 300 actually.

Furthermore, in one aspect of the present embodiment, only when the USB dongle 200 and the NAS 300 exist in such a range as to be capable of communicating with each other (in a wireless LAN area), the USB dongle 200 performs wireless LAN communication with the NAS 300 to provide a virtual memory region (memory region made to look as if it existed in the USB dongle 200) to the host PC 100. Due to this, it is impossible for the USB dongle 200 to access the NAS 300 when the distance between the USB dongle 200 and the NAS 300 is comparatively long and they cannot communicate with each other. That is, due to this, only the limited user can access the NAS 300. In addition, in a certain aspect of the present embodiment, a log of reading/writing may be created and encryption of data may be performed as already described.

### Modification Example 1

In another aspect of the embodiment, the USB dongle 200 and the NAS 300 may indirectly communicate with each other instead of performing wireless communication with each other directly.

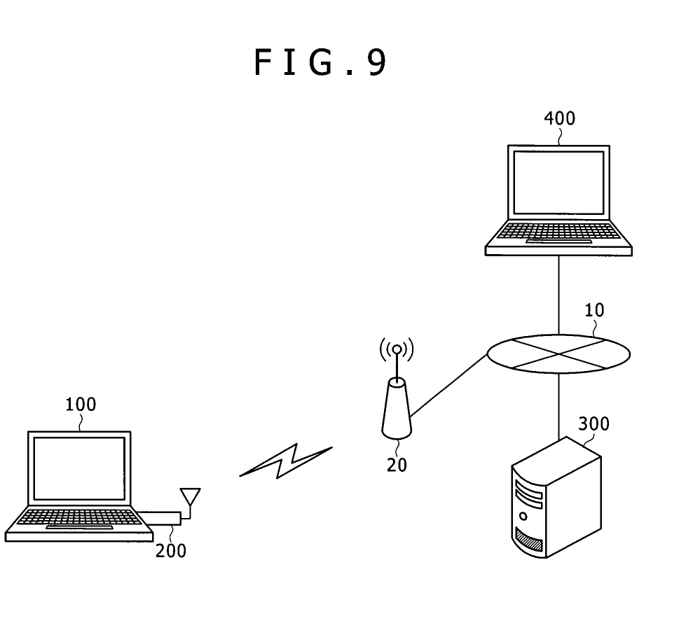

FIG. 9 is an overall configuration diagram of a communication system according to another aspect of the present embodiment. As shown in FIG. 9, the communication system according to this aspect further includes an access point (AP) 20 connected to the network 10. The wireless LAN module 204 of the USB dongle 200 performs communication compliant with the wireless LAN with the AP 20. Furthermore, the CPU 202 of the USB dongle 200 establishes a wireless LAN session with the AP 20 and then establishes an iSCSI session with the NAS 300.

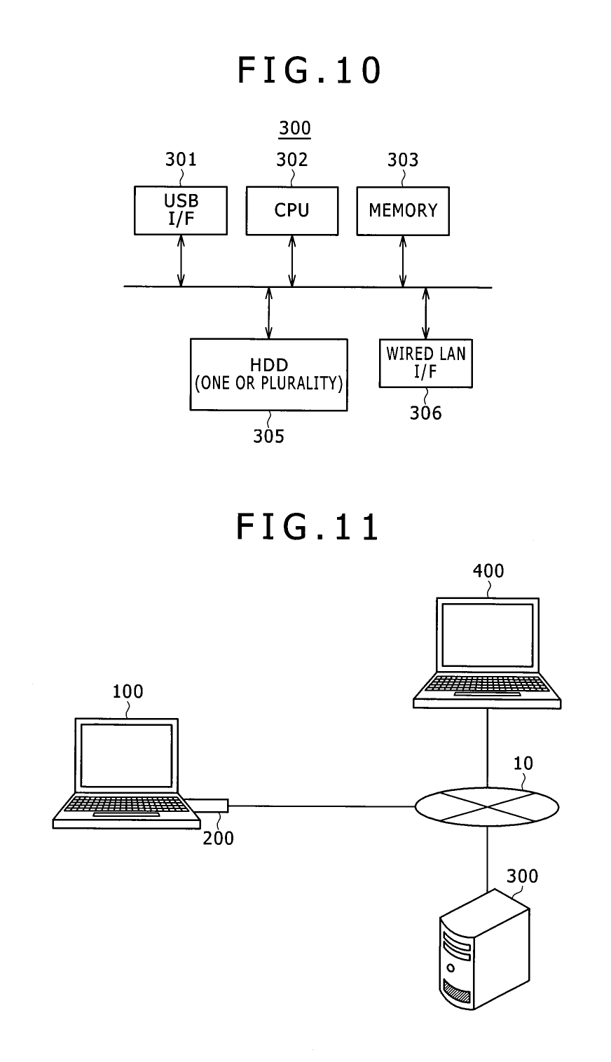

FIG. 10 is a block diagram of the NAS 300 according to this aspect. As shown in FIG. 10, the NAS 300 used in this aspect does not need to include the above-described wireless LAN module 304. The wired LAN I/F 306 is used for communication with the USB dongle 200.

Also in this aspect, the USB dongle 200 provides a virtual memory region to the host PC 100 only when existing in the communicable range of the AP 20 (in a wireless LAN area). Due to this, it is impossible for the USB dongle 200 to access the NAS 300 when the USB dongle 200 is distant from the AP 20 and exists outside the communicable range of the AP 20.

### Modification Example 2

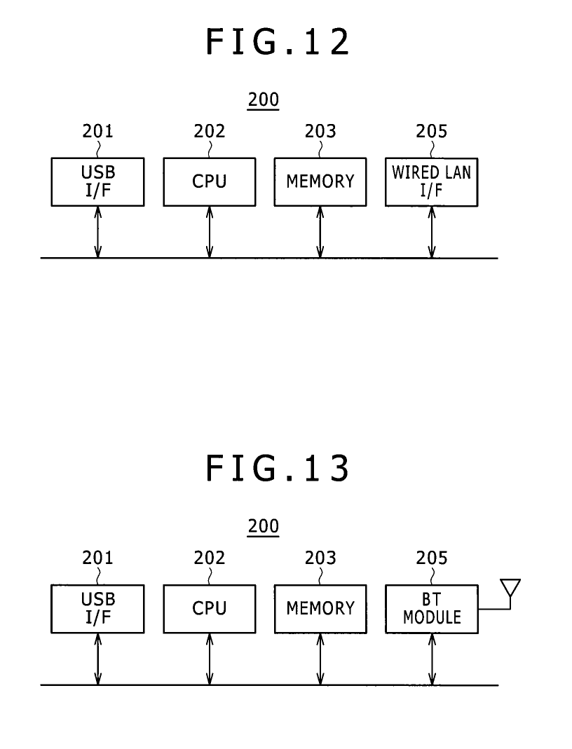

In further another aspect of the present embodiment, the USB dongle 200 may give and receive command and data to and from the NAS 300 by performing wired communication instead of wireless communication. FIG. 11 is an overall configuration diagram of a communication system according to this aspect. As shown in FIG. 11, in the communication system according to this aspect, the USB dongle 200 is connected to the network 10 via a LAN cable or the like. In this case, setting of the information for establishing a wireless LAN session (ESSID and encryption key) can be omitted in the initial setting of the USB dongle 200. FIG. 12 is an example of a block diagram of the USB dongle 200 according to this aspect. As shown in FIG. 12, the USB dongle 200 according to this aspect does not need to include the above-described wireless LAN module 204 but includes a wired LAN I/F 205.

### Modification Example 3

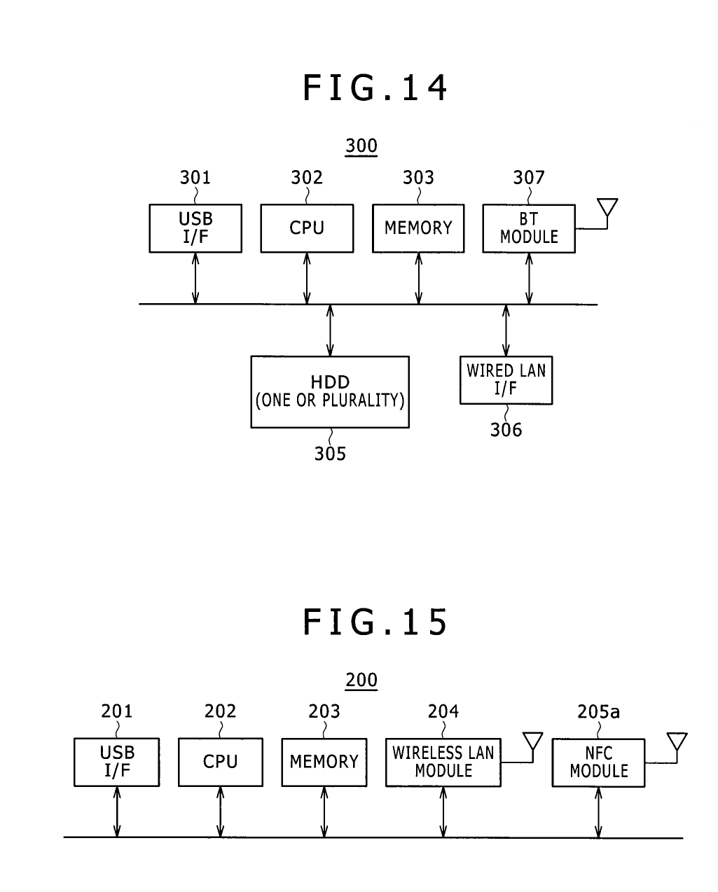

In further another aspect of the present embodiment, the USB dongle 200 and the NAS 300 perform Bluetooth (BT) communication instead of wireless LAN communication. The iSCSI protocol is a protocol in which the SCSI command is encapsulated and exchanged, and is irrespective of the configuration of the lower layer. Therefore, the BT may be used. FIG. 13 is a block diagram of the USB dongle 200 according to this aspect. As shown in FIG. 13, the USB dongle 200 according to this aspect includes a BT module 206 instead of the above-described wireless LAN module 204. FIG. 14 is a block diagram of the NAS 300 according to this aspect. As shown in FIG. 14, the NAS 300 according to this aspect includes a BT module 307 instead of the above-described wireless LAN module 304.

BT communication is performed between these BT module 206 and BT module 307. Because the specific method of the BT communication is widely known, description of the specific content thereof is omitted. Also in this example, the USB dongle 200 accepts information on the encryption key used in the BT communication and so forth from the NAS 300 and stores it in advance.

### Modification Example 4

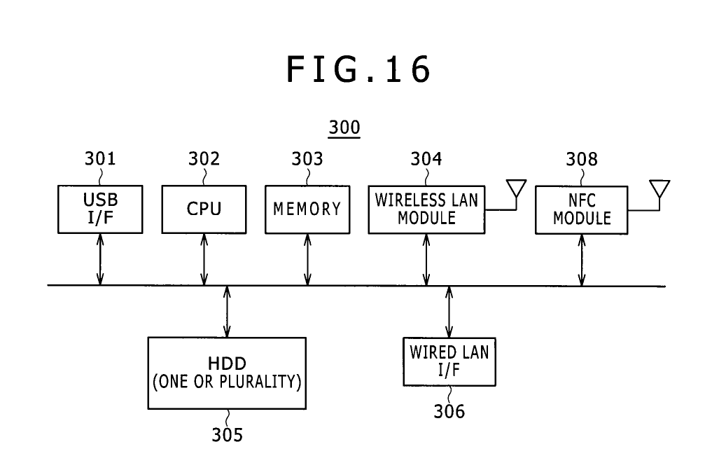

In the respective aspects of the above-described embodiment, examples in which the USB I/F is used in the initial setting of the USB dongle 200 are described. However, the near field communication (NFC) may be used instead of the USB I/F. The NFC is a technique of wireless communication (RFID) across a distance of several tens of centimeters. FIG. 15 is a block diagram of the USB dongle 200 when the NFC is utilized. As shown in FIG. 15, the USB dongle 200 of this case further includes an NFC module 205a. FIG. 16 is a block diagram of the NAS 300 of the case of this example. As shown in FIG. 16, the NAS 300 of this case further includes an NFC module 308. Furthermore, in this case, the NAS 300 does not need to have the USB I/F 301.

In this example, in the initial setting of the USB dongle 200, the USB dongle 200 receives and stores, from the NAS 300, the parameters necessary for communication with the NAS 300 via communication between the NFC module 205a and the NFC module 308.

### Other Aspects of the Embodiment

Although the respective aspects of the embodiment of the present invention are described as above, it should not be understood that the disclosure made here limits this invention. From this disclosure, various alternative aspects of the embodiment, working examples, and operational techniques will be apparent for those skilled in the art.

For example, in the above-described aspects of the embodiment, the range of the assigned region assigned to the USB dongle 200 is specified by the administrator PC 400. However, for example if one or plural USB dongles 200 and the NAS 300 are sold as a set, the ranges of the assigned regions assigned to the respective USB dongles 200 as the set may be set in shipment.

Encryption and decryption by an encryption key may be omitted in terms of reduction in the processing load.

In the above-described aspects of the embodiment, examples in which the USB dongle 200 is used as one example of the communication equipment are described. However, the communication equipment of the present disclosure may use an interface other than the USB I/F. For example, the IEEE 1394 I/F or ThunderBolt can be used instead of the USB I/F. For example, the device class equivalent to the mass storage class exists in the IEEE 1394 I/F similarly to the USB I/F. Also when the IEEE 1394 I/F or another interface is used like this example, the USB dongle 200 notifies the host PC 100 of device class information indicating that this USB dongle 200 is a storage similarly to the case of using the USB I/F.

While the present disclosure is described in terms of preferred or exemplary embodiments, it is not limited hereto.

In the drawings:
103: Memory
105: Display
106: Keyboard
107: Mouse
204: Wireless LAN Module
305: HDD (One or Plurality)
306: Wired LAN I/F
400: Administrator PC
200: USB Dongle
S101: Login with Administrator Rights
S102: Provision of Initial Setting Screen
S103: Setting Operation
S104: Assignment of HDD Region
S105: Setting of Identification Information of Dongle
S106: Connection of USB Dongle to NAS
S107: Identification Information, Device Class Information
S108: Discrimination of Identification Information
S109: Setting Information (Encryption Key)
100: Host PC
S201: Connection of USB Dongle to Host PC
S203: Setup
S204: Recognition as Mass Storage
S205: Request for Establishment of Wireless LAN Session
S206: Wireless LAN Authentication
S207: Request for Establishment of iSCSI Session
S208: iSCSI Authentication
S212: SCSI Command (Encapsulation Based on iSCSI)
S213: Creation of Disk Information
S302: Read Command (iSCSI Encapsulation)
S311: Read Data, Command Complete
S401: Write Command
S403: Write Data
206: BT Module

What is claimed is:

1. Communication equipment comprising:
an interface configured to be electrically connected to information terminal equipment;
a communication mechanism that performs communication with storage equipment that has a region assigned to the communication equipment; and
a controller that transmits device class information indicating that the communication equipment is of a mass storage class to information terminal equipment in response to the communication equipment being connected to the information terminal equipment via the interface, wherein
the controller transfers an accepted inquiry command relating to a memory region to the storage equipment in response to accepting the inquiry command from the information terminal equipment, and
the controller receives memory region information relating to the assigned region from the storage equipment by the communication mechanism and transfers the received memory region information to the information terminal equipment.

2. The communication equipment according to claim 1, wherein
in response to receiving, via the interface, a read command from information terminal equipment connected via the interface, the controller transfers the received read command to the storage equipment, and
in response to read data from the storage equipment being received by the communication mechanism, the controller transfers the read data to the information terminal equipment.

3. The communication equipment according to claim 1, wherein
in response to the interface receiving a write command from information terminal equipment connected via the interface, the controller transfers the write command to the storage equipment, and
in response to the interface receiving write data from the information terminal equipment, the controller transfers the write data to the storage equipment.

4. The communication equipment according to claim 1, wherein
the interface is a universal serial bus interface.

5. The communication equipment according to claim 1, wherein
the communication mechanism performs communications compliant with a wireless local area network communication protocol.

6. The communication equipment according to claim 1, wherein
the controller performs communication with the storage equipment by Internet Protocol packet communication.

7. The communication equipment according to claim 6, wherein
an Internet Small Computer System Interface protocol is used for the Internet Protocol packet communication.

8. The communication equipment according to claim 1, wherein
in response to the interface receiving an inquiry command from information terminal equipment connected to the interface before communication with the storage equipment is established, the controller transmits a negative acknowledgement to the information terminal equipment, and
in response to the interface receiving an inquiry command from information terminal equipment connected to the interface after communication with the storage equipment is established, the controller transfers the received inquiry command to the storage equipment.

9. The communication equipment according to claim 1, wherein
the controller receives setting information for communication with the storage equipment and/or an encryption key for encrypting data from the storage equipment and stores the setting information and/or the encryption key.

10. The communication equipment according to claim 1, wherein
the controller performs encryption of write data and decryption of read data by using an encryption key shared with the storage equipment.

11. Storage equipment comprising:
a storage device configured to store data;
a communications mechanism that performs communication with communication equipment; and
a controller that sets an assigned region associated with communication equipment in the storage device,
wherein
in response to the communication mechanism receiving an inquiry command relating to a memory region from communication equipment, the controller transmits memory region information relating to an assigned region associated with the communication equipment as a transmission source of the inquiry command to the communication equipment.

12. The storage equipment according to claim 11, wherein
the controller receives an identifier of the communication equipment from the communication equipment and transmits, to the communication equipment, setting information for communication with the storage equipment by the communication equipment and/or an encryption key if an identifier registered in advance corresponds with the received identifier.

13. The storage equipment according to claim 11, wherein
the communication equipment performs communications that is compliant with wireless local area network communication.

14. The storage equipment according to claim 11, wherein
the controller performs communications with the communication equipment by Internet Protocol packet communication.

15. The storage equipment according to claim 14, wherein
an Internet Small Computer System Interface protocol is used for the Internet Protocol packet communication.

16. The storage equipment according to claim 11, wherein
the controller records a log of writing/reading when having performed the writing/reading to/from an assigned region associated with the communication equipment in response to a command from the communication equipment.

17. The storage equipment according to claim 11, wherein
the controller performs encryption of data as a subject of writing and decryption of data as a subject of reading by using an encryption key shared with the communication equipment.

18. A communication method comprising:
by communication equipment, transmitting device class information indicating that the communication equipment is of a mass storage class to information terminal equipment in response to the communication equipment being electrically connected to the information terminal equipment via an interface of the communication equipment;
by the communication equipment, establishing communication with storage equipment having an assigned region assigned to the communication equipment;
by the information terminal equipment, recognizing the communication equipment as a device of the mass storage class in accordance with the device class information and transmitting an inquiry command relating to a memory region to the communication equipment;
by the communication equipment, transferring the inquiry command to the storage equipment in response to receiving the inquiry command from the information terminal equipment;
by the storage equipment, transmitting memory region information relating to the assigned region assigned to the communication equipment to the communication equipment in response to receiving the inquiry command from the communication equipment; and
by the communication equipment, receiving the memory region information from the storage equipment and transferring the received memory region information to the information terminal equipment.
